(19) United States
(12) Patent Application Publication
(10) Pub. No.: US 2005/0031492 A1
(43) Pub. Date: Feb. 10, 2005

(54) Electronic device, analysis system, and conveyance device

(75) Inventor: Hiroki Koike, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 10/888,127

(22) Filed: Jul. 9, 2004

(30) Foreign Application Priority Data
Jul. 10, 2003 (JP) 2003-194809

(51) Int. Cl. G01N 27/00

(52) U.S. Cl. 422/82.01

(57) ABSTRACT

Electronic devices are described that include an electronic device body; a cover mounted on the electronic device body; a conducting member providing electrical continuity between the electronic device body and the cover; and a positioning member for determining the relative positions of the electronic device body and the cover, including a convexity provided on either the electronic device body or the cover, and a concavity provided on the other among the electronic device body or the cover, the convexity and the concavity being engageable one another. Analysis systems and conveyance devices are also described.

### FIELD OF THE INVENTION

The present invention relates to an electronic device, analysis system and conveyance device, and more specifically relates to an electronic device having a cover, analysis system, and conveyance device.

### BACKGROUND

Among conventional electronic devices having a cover, there are known electronic devices which are constructed such that the electronic device body and the cover have electrical continuity to prevent electrical charging to the cover (for example, refer to Japanese Laid-Open Patent Publication No. H7-154273).

This patent publication discloses an electronic device having a structure in which claws of a cover engage the four exterior side surfaces of an electronic device body so as to determine the relative positions of the electronic device body and cover.

Furthermore, conventional conveyance devices for supplying a sample to an analyzer are known as examples of a large-scale electronic device constructed so as to provide electrical continuity between the electronic device body and cover (for example, Japanese Laid-Open Utility Model Publication No. H3-74359).

In the structure disclosed in Japanese Laid-Open Patent Publication No. H7-154273, however, a problem arises inasmuch as freedom of design is reduced by the requirement of having four side surfaces on the electronic device body so as to determine the relative positions of the electronic device body and cover.

In the structure disclosed in Japanese Laid-Open Patent Publication No. H7-154273, further problems arise inasmuch as objects and the like catch on the exposed claws of the cover because the structure has the claws exposed to the outer side of the four side surfaces of the electronic device. In particular, when the structure disclosed in Japanese Laid-Open Patent Publication No. H7-154273 is applied to a large-scale electronic device, such as the conveyance device used with an analyzer disclosed in Japanese Laid-Open Utility Model Publication No. H3-74359, a problem arises inasmuch as objects become readily caught on the large claws because the large claws are exposed on the exterior of the electronic device body.

### SUMMARY

The scope of the present invention is defined solely by the appended claims, and is not affected to any degree by the statements within this summary.

First electronic device, analysis system, and conveyance device embodying features of the present invention improve freedom of design and do not give rise to the inconvenience of objects becoming caught on parts of the positioning members that are exposed on the exterior.

Second electric device embodying features of the present invention includes an electronic device body; a cover mounted on the electronic device body; a conducting member providing electrical continuity between the electronic device body and the cover; and a positioning member for determining the relative positions of the electronic device body and the cover, including a convexity provided on either the electronic device body or the cover, and a concavity provided on the other among the electronic device body or the cover, the convexity and the concavity being engageable one another.

Third electronic device embodying features of the present invention includes an electronic device body; a cover mounted on the electronic device body; a conducting member providing electrical continuity between the electronic device body and the cover; positioning members for determining the relative positions of the electronic device body and the cover; wherein the positioning member is provided in an inner part of a space formed by mounting a cover on the electronic device body.

Second conveyance device embodying features of the present invention for transporting a specimen container accommodating a specimen includes a device body including a container transfer for transporting a specimen container; a cover mounted on the device body; a conducting member for providing electrical continuity between the cover and the device body; and positioning members for determining the relative positions of the device body and the cover.

### BRIEF DESCRIPTION OF THE DRAWINGS

FIG. 1 is a perspective view showing the overall structure of an analysis system including a first conveyance device (electronic device) of an embodiment of the present invention;

FIG. 2 is a brief illustration of the operation of the analysis system of FIG. 1;

FIG. 3 is a perspective view of the first conveyance device of the embodiment shown in FIG. 1;

FIG. 4 is an exploded perspective view of the first conveyance device of the embodiment shown in FIG. 1;

FIG. 5 is a perspective view from the back side of the cover of the first conveyance device of the embodiment shown in FIG. 4;

FIG. 6 is a perspective view showing details of area A of the first conveyance device of the embodiment shown in FIG. 4;

FIG. 7 is a cross section view illustrating the positional relationship of the guide member provided with an insertion hole and the positioning pin of the first conveyance device of the embodiment shown in FIG. 6;

FIG. 8 is a cross section view illustrating the positional relationship of the flat spring connector and the flat spring of the first conveyance device of the embodiment shown in FIG. 6;

FIG. 9 is a perspective view showing details of area B of the first conveyance device of the embodiment shown in FIG. 4;

FIG. 10 is a cross section view illustrating the positional relationship of the flat spring connector and the flat spring shown in FIG. 9;

FIG. 11 is a brief illustration of a method of mounting the cover of the first conveyance device of the embodiment shown in FIG. 4;

FIG. 12 is a brief illustration of a method of mounting the cover of the first conveyance device of the embodiment shown in FIG. 4;

FIG. 13 is a brief illustration of a method of mounting the cover of the first conveyance device of the embodiment shown in FIG. 4;

FIG. 14 is a cross section view showing the state of the connection between the flat spring connector and the flat spring shown in FIG. 13; and

FIG. 15 is a cross section view showing the state of the connection between the flat spring connector and the flat spring shown in FIG. 10.

### DETAILED DESCRIPTION OF THE EMBODIMENT

The embodiments of the present invention are described hereinafter with reference to the drawings.

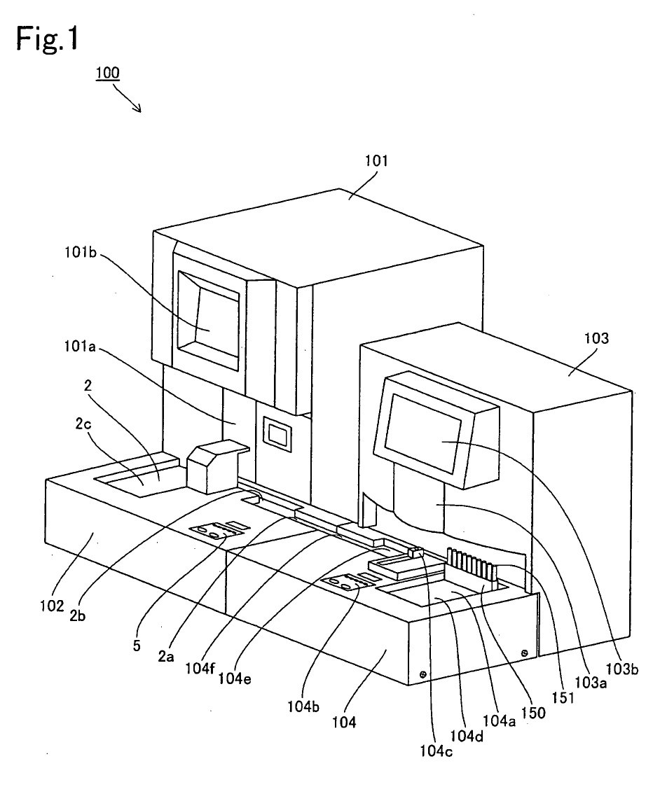

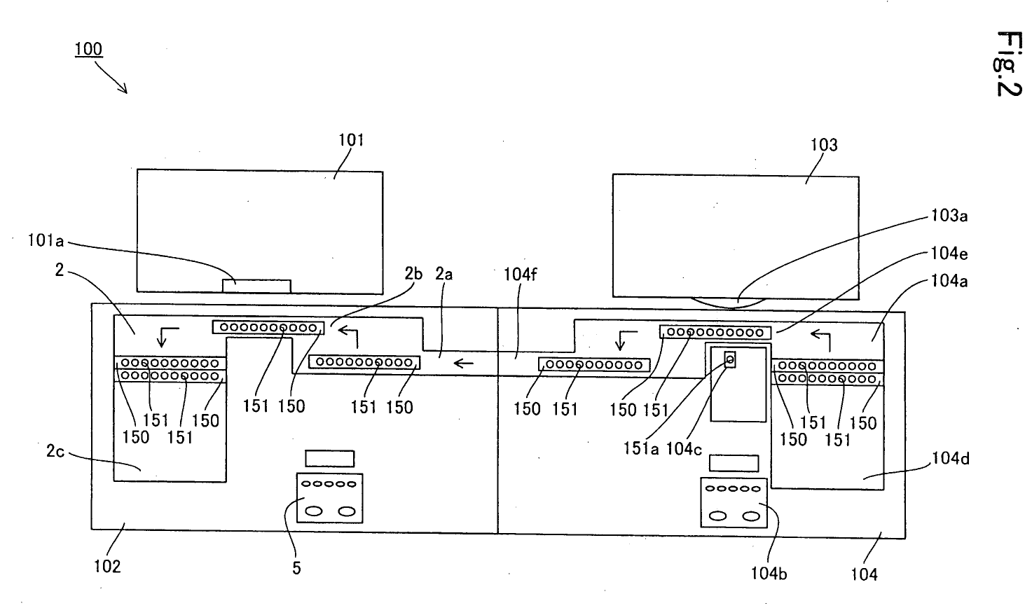

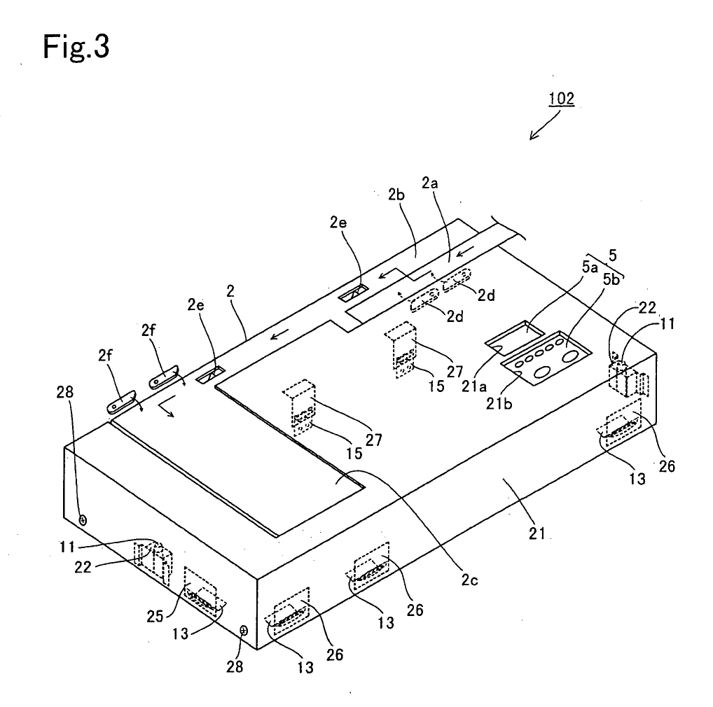

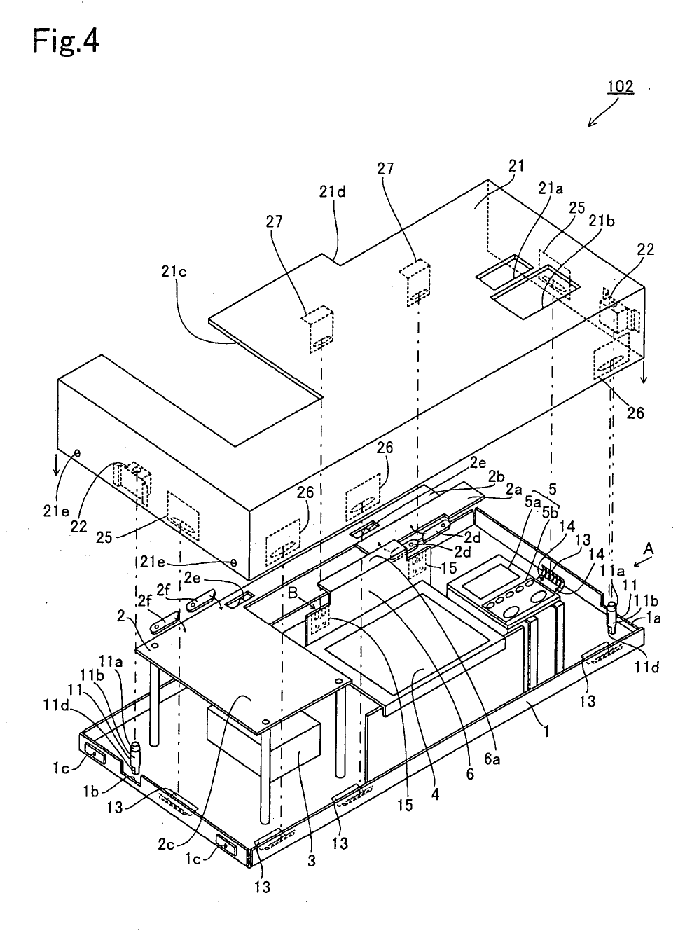

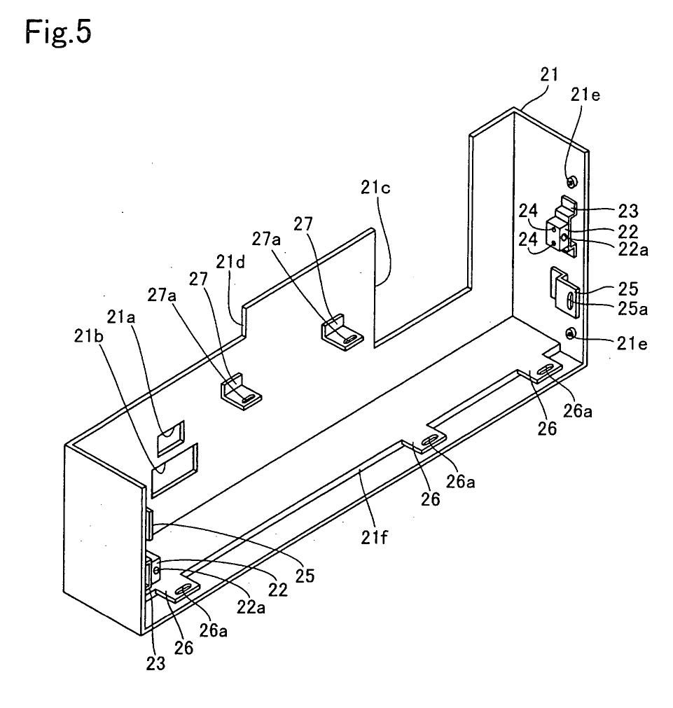

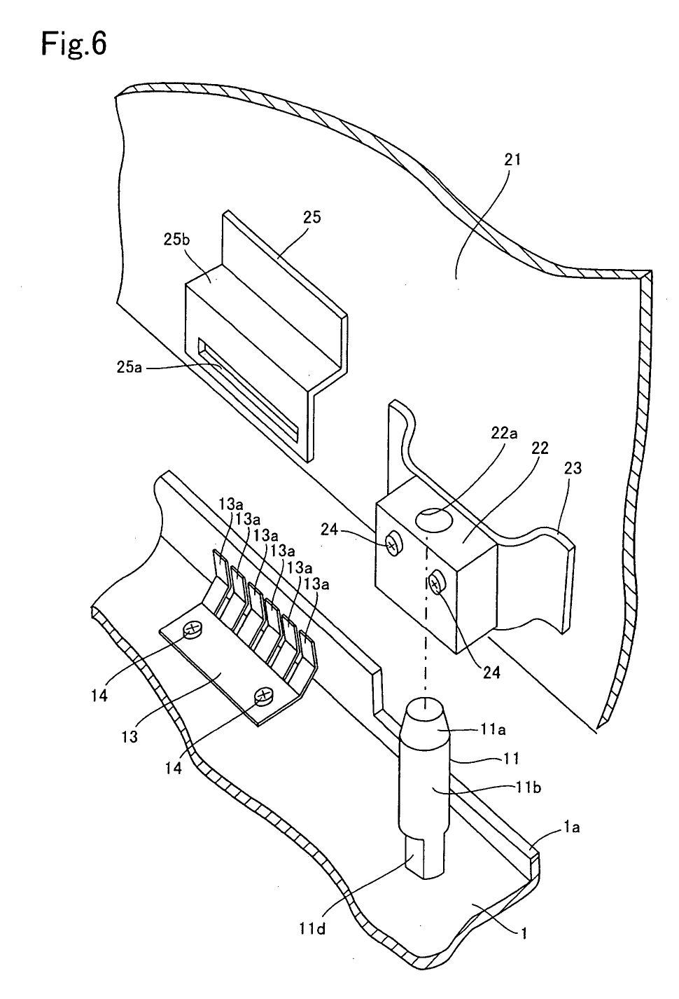

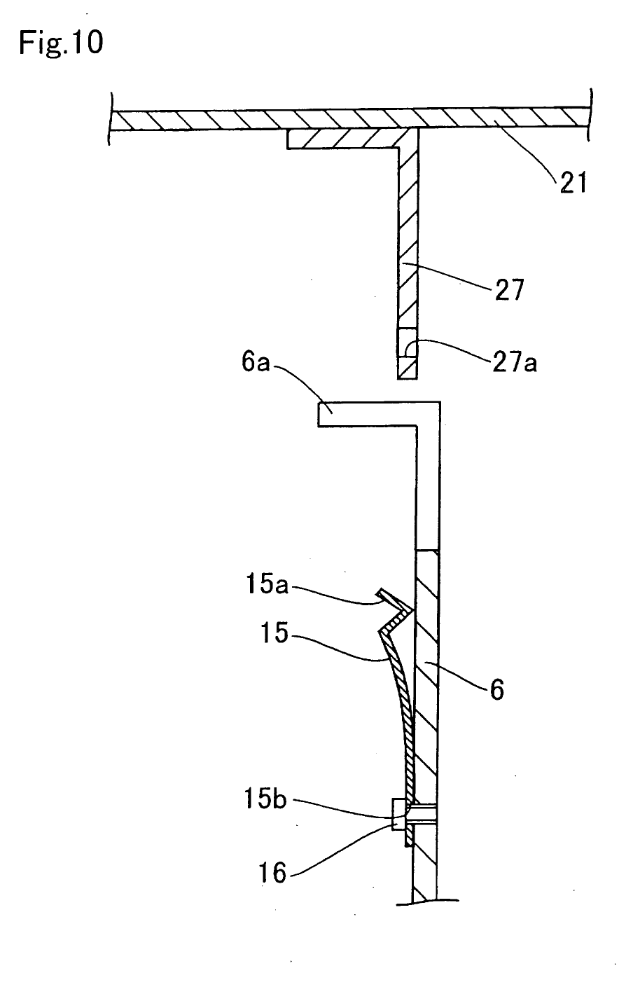

FIG. 1 is a perspective view of the overall structure of an analysis system incorporating the first conveyance device of an embodiment of the present invention. FIG. 2 is a brief illustration of the operation of the analysis system shown in FIG. 1. FIG. 3 is a perspective view of an embodiment of the first conveyance device shown in FIG. 1, and FIG. 4 is an exploded perspective view of FIG. 3. FIG. 5 is a perspective view from the back side of the cover shown in FIG. 4. Furthermore, FIGS. 6 through 10 are perspective views and cross section views illustrating the structure of the conduction members and positioning members used in the first conveyance device shown in FIG. 4.

The general structure and operation of the main embodiment of the analysis system is described below with reference to FIGS. 1 and 2. The analysis system of this embodiment is provided with a first analyzer 101, first conveyance device 102, second analyzer 103, and second conveyance device 104, as shown in FIG. 1. The first analyzer 101 and second analyzer 103 may be, for example, urine analyzers. In this case, the first analyzer 101 is connected to the back part of the second analyzer 103, and is thus situated to perform detailed analysis and examination of the urine examination result of the second analyzer 103. The first conveyance device 102 is a device for automatically supplying specimen to the first analyzer 101, and the second conveyance device 104 is a device for automatically supplying specimen to the second analyzer 103.

The first analyzer 101 includes an assay unit 101a and a display unit 101b. Furthermore, the second analyzer 103 includes an assay unit 103a and a display unit 103b. The first conveyance device 102 includes a conveyance unit 2 for transporting a specimen rack 150 which accommodates a plurality (10 in the present embodiment) of specimen containers 151 which hold specimens, and a setting unit 5 for setting the operation of the first conveyance device 102. Furthermore, the conveyance unit 2 includes a transport unit 2a, transverse feeder unit 2b, and collection unit 2c. The second conveyance device 104 includes a conveyance unit 104a for transporting a specimen rack 150 which accommodates a plurality of specimen containers 151 that hold specimens, a setting unit 104b for setting the operation of the second conveyance device 104, and an interrupt specimen processing unit 104c used when interrupting a normal specimen assay for examination. Furthermore, the conveyance unit 104a includes a transport unit 104d, transverse feeder unit 104e, and discharge unit 104f.

The operation of the analysis system of the present embodiment provides automatic transport of the specimen rack 150 accommodating a plurality of specimen containers 151 loaded with specimens (urine) in the arrow direction of FIG. 2, as shown in FIG. 2. Specifically, first, the specimen rack 150 accommodating a plurality of specimen containers 151 loaded with specimens is placed into the transport unit 104d of the second conveyance unit 104. Then, the start key of the setting unit 104b is pressed. In this way the specimen rack 150 placed in the transport unit 104d of the second conveyance unit 104 is transported to the transverse feeder unit 104e. The specimen rack 150 is transported to in front of the assay unit 103a of the analysis unit 103 by the incremental transverse feeding of the specimen rack 150 one specimen container 151 at a time by the transverse feeder unit 104e. Then, by the assay unit 103a of the second analysis unit 103, the specimens contained within the specimen containers 151 accommodated in the specimen rack 150 are sequentially assayed. Subsequently, after the specimen rack 150 has been transported from the transverse feeder unit 104e to the discharge unit 104f, the specimen rack 150 is carried to the transport unit 2a of the first conveyance device 102. Then, the first conveyance device 102 detects the arrival of the specimen rack 150 at the transport unit 2a, and starts operation.

The specimen rack 150, which has been transported by the transport unit 2a of the first conveyance device 102, is transferred to the transverse feeder unit 2b of the first conveyance device 102. Then, the specimen rack 150 is transported to in front of the assay unit 101a of the first analysis unit 101 by the incremental transverse feeding of the specimen rack 150 one specimen container 151 at a time by the transverse feeder unit 2b. By the assay unit 101a of the first analysis device 101, only those specimens determined to require detailed urinalysis by the first analysis device 101 are assayed based on the urinalysis results of the second analysis device 103. Thereafter, the specimen rack 150 is transported from the transverse feeder unit 2b to the collection unit 2c. The above-described operation is sequentially performed for each specimen rack 150. When an assay is performed by interrupting a normal specimen assay using the specimen rack 150, the specimen container 151a accommodating the specimen is disposed at the interrupt specimen processing unit 104c, and the specimen is assayed by the assay unit 103a of the second analysis device 103.

Details of the structure of the first conveyance device 102 of the embodiment of the present invention are described below with reference to FIGS. 3 through 10. The first conveyance device 102 is provided with a metal chassis 1, and a metal cover 21, which is entirely coated with an insulation material, as shown in FIGS. 3 and 4. The conveyance unit 2, which includes a transport unit 2a, transverse feeder unit 2b, and collection unit 2c, is arranged on the chassis 1. Furthermore, turn levers 2d are provided near the transport unit 2a for moving the specimen rack 150 (refer to FIG. 2), which has been delivered to the transport unit 2a, to the transverse feeder unit 2b side. A claw 2e is provided on the transverse feeder unit 2b for incrementally transverse feeding the specimen rack 150 one specimen container 151 at a time. Turn levers 2f are provided near the collection unit 2c for moving the specimen rack 150, which has been transported from the transverse feeder unit 2b, to the collection unit 2c side.

As shown in FIG. 4, a power unit 3 is provided on the top surface of the chassis 1 below the collection unit 2c. Furthermore, a control board 4 and setting unit 5 are arranged on the chassis 1. The setting unit 5 includes an LCD panel 5a as a display unit, and a key input unit 5b having a start key and the like. Also provided on the chassis 1 is a cover top panel support member 6 having a top surface part 6a for supporting the center part of the top surface of the cover 21.

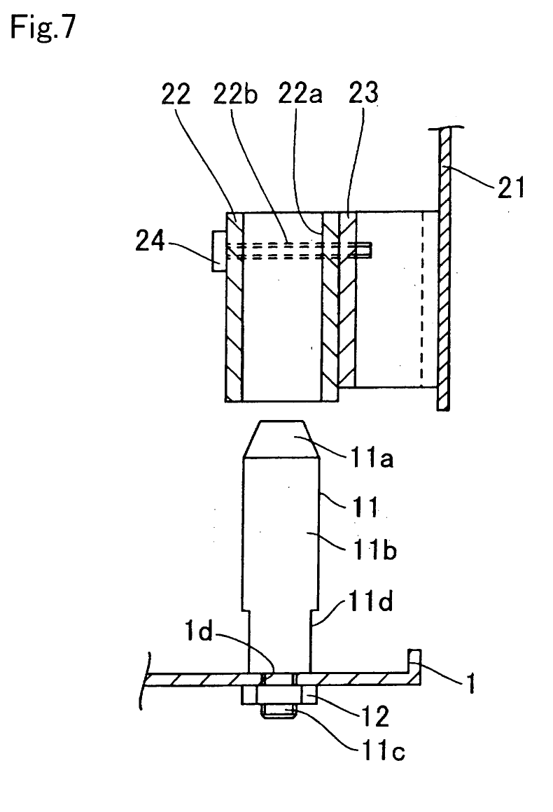

In the present embodiment, two metal (for example, stainless steel) positioning pins 11 are mounted with lateral asymmetry (on the diagonal) on the top surface of the chassis 1. As shown in FIGS. 4 and 7, the positioning pins 11 include a tapered part 11a provided at the tip, positioning part 11b, threaded part 11c provided at the base, and smooth part lid provided between the threaded part 11c and the positioning part 11b. The tip of the tapered part 11a has a smaller diameter than that of the positioning part 11b. The smooth part lid is constructed so as to enable it to be gripped by a tightening tool, such as a wrench or the like.

When mounting the positioning pins 11, the threaded part 11c is inserted into the threaded hole 1d of the chassis 1, and in this state the threaded part 11c is fixedly attached by a nut 12 from the back surface of the chassis 1, as shown in FIG. 7. In this case, the nut 12 is tightened when the smooth part 11d of the positioning pin 11 is gripped by a tightening tool, such as a wrench or the like.

Notches 1a and 1b are formed on the side surface of chassis 1 opposite the two positioning pins 11, as shown in FIG. 4. Two female threaded parts 1c are provided on the front left side surface of the chassis 1 for anchoring the cover 21.

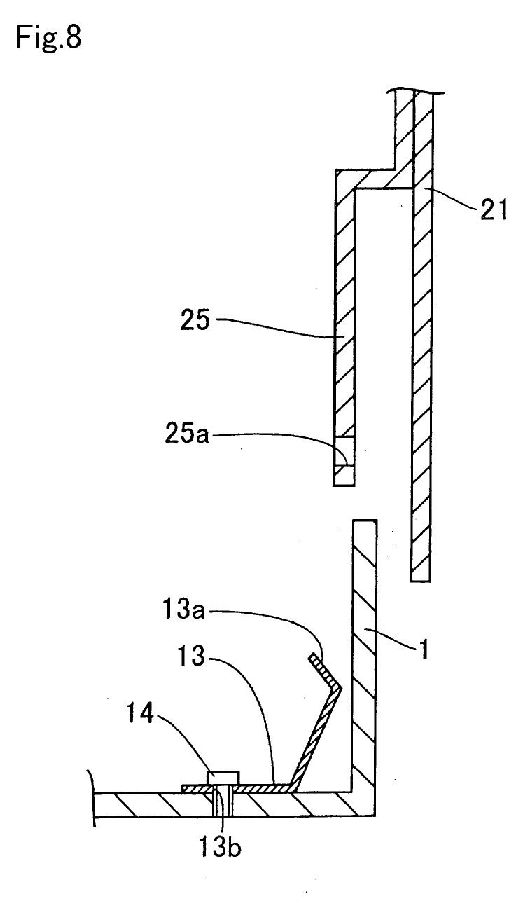

In the present embodiment, five flat springs 13 and two flat springs 15 are mounted on the side of the chassis 1 for electrical continuity with the cover 21. The five flat springs 13 are respectively mounted near three side surfaces of the chassis 1, and the two flat springs 15 are respectively mounted on the cover top panel support member 6 of the chassis 1. The flat springs 13 have six contacts 13a and screw holes 13b, as shown in FIGS. 6 and 8. The contacts 13a of the flat springs 13 have convexities which protrude toward the side surface of the chassis 1. The flat springs 13 are mounted to the chassis 1 by screws 14 so as to have the convexity of the contact 13a positioned near the side surface of the chassis 1. The flat springs 15 have a contact 15a, which is divided into three parts, and screw holes 15b. The contacts 15a of the flat spring 15 have convexities which protrude toward the side surface of the cover top panel support member 6. The flat springs 15 are mounted by screws 16 on the side surface of the cover top panel support member 6.

As shown in FIGS. 4 and 5, openings 21a and 21b are provided in the cover 21 at positions respectively corresponding to the LCD panel 5a and key input unit 5b of the setting unit 5 mounted on the side of the chassis 1. Furthermore, notches 21c and 21d are provided on the cover 21 so as to expose the conveyance unit 2. Screw holes 21e are provided on the cover 21 corresponding to the female threaded part 1c of the chassis 1.

As shown in FIGS. 5 and 7, resin (for example, polyacetal resin) guide members 22 having an insertion hole 22a and screw hole 22b are provided on the cover 21 at positions corresponding to the positioning pins 11 on the sides of the chassis 1. The resin guide member 22 is mounted on a metal foot 23, which is integratedly joined to the cover 21 by welding or the like, by means of screw anchoring using screws 24. A positioning member is formed by the positioning pins 11, and the guide member 22 provided with an insertion hole 22a so as to determine the relative positions of the chassis 1 and the cover 21.

Furthermore, two metal flat spring connectors 25 and three metal flat spring connectors 26 are provided on the cover 21 so as to engage the five flat springs 13 mounted on the side of the chassis 1, as shown in FIGS. 4 and 5. The flat spring connectors 25 are integratedly mounted by welding or the like on the side surfaces of the cover 21, on which is mounted on the guide member 22. The flat spring connector 25 has a step part 25b and a slot 25a for engaging the convexity of the contact 13a of the flat spring 13, as shown in FIG. 6. The flat spring connectors 26 are integratedly formed at a predetermined equal spacing on the step part 21f of the cover 21, and have a slot 26a for engaging the convexity of the contact 13a of the flat spring 13, as shown in FIG. 5.

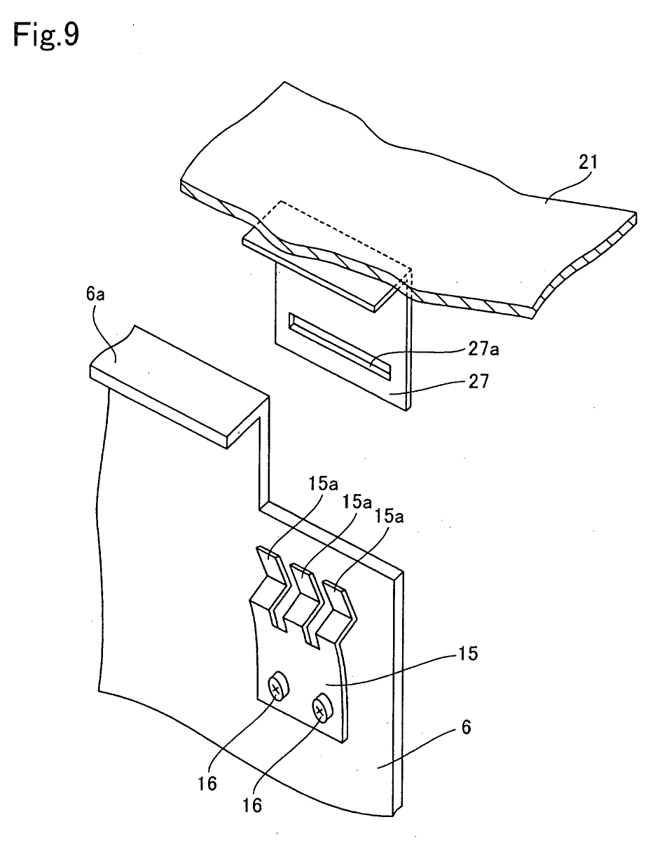

Metal flat spring connectors 27 are integratedly mounted on the cover 21 by welding or the like at positions of the top panel corresponding to the flat springs 15 mounted on the cover top panel support member 6. As shown in FIGS. 5 and 9, the flat spring connectors 27 have an L-shaped configuration, and slots 27a for engaging the convexity of the contacts 15a of the flat springs 15. Insulation coating is not provided on at least the slots 25a through 27a of the flat spring connectors 25 through 27 so as to obtain electrical continuity with the flat springs 13 and 15. A conducting member is formed by the flat springs 13 and 15 and flat spring connectors 25 through 27 to provide electrical continuity with the chassis 1 and the cover 21.

As shown in FIG. 6, the positioning member which includes a positioning pin 11 and a guide member 22 and the conducting member which includes a flat spring 13 and a flat spring connector 25 are closely disposed. The positioning member and the conduct member are disposed on the same side of the cover 21.

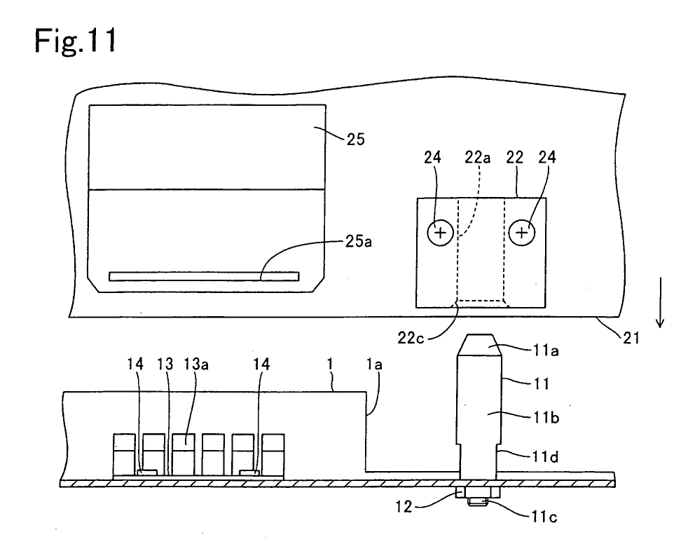

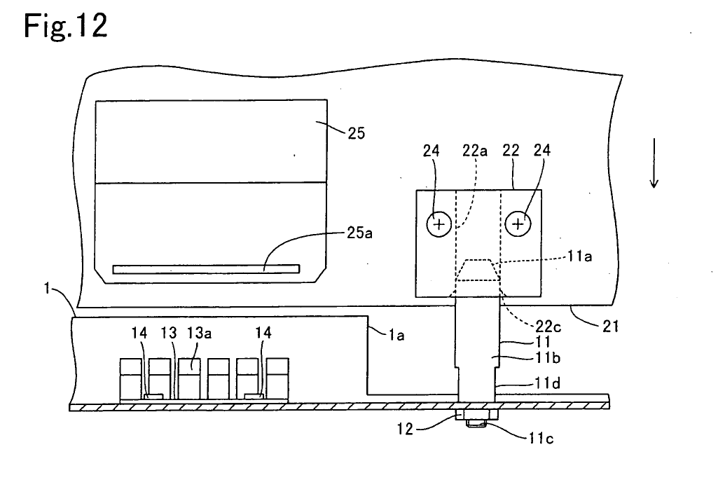

The method of mounting the cover 21 of the first conveyance device 102 of the present embodiment is described below with reference to FIGS. 3 through 15. First, as shown in FIG. 4, the cover 21 is gradually lowered downward from above onto the chassis 1. Before positioning the cover 21 relative to the chassis 1, area A of FIG. 4 is in the state shown in FIG. 11. Then, from the state shown in FIG. 11, the cover 21 is lowered such that the two laterally asymmetrically arranged positioning pins 11 (refer to FIG. 4) are inserted into the insertion holes 22a of the guide member 22. In this case, since a tapered part 11a, which has a tip with a smaller diameter than that of the positioning part 11b of the positioning pin 11, is provided at the tip of the positioning pin 11, and a beveled part 22c is provided on the positioning pin 11 side of the guide member 22, during initial positioning, the tip of the positioning pin 11 is readily inserted into the insertion hole 22a of the guide member 22 even if there is a slight dislocation in the positional relationship between the positioning pin 11 and the insertion hole 22a of the guide member 22. In this way, the state shown in FIG. 12 is achieved.

The state shown in FIG. 12 is both a state wherein the positioning pin 11 engaged with the insertion hole 22a of the guide member 22, and a state wherein the flat spring 13 and the flat spring connector 25 are not engaged. That is, in the present embodiment, the flat springs 13 and the flat spring connectors 25 engage after the cover 21 and the chassis 1 have been positioned by the positioning pins 11 and the guide members 22. In this way, the engagement of the flat springs 13 and the flat spring connectors 25 can be smoothly accomplished.

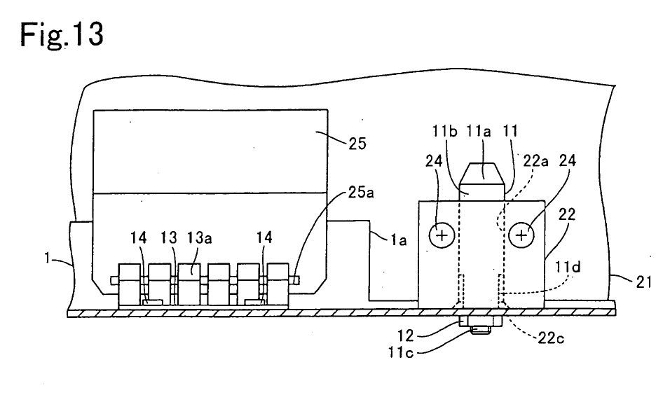

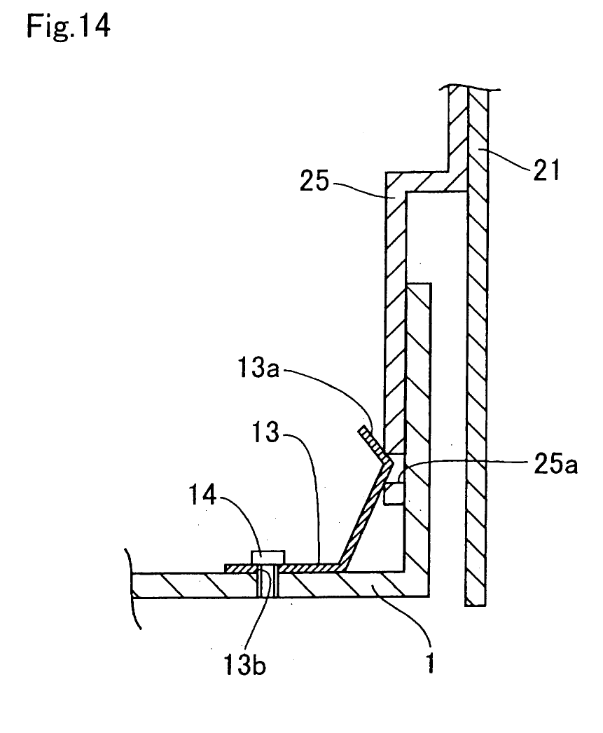

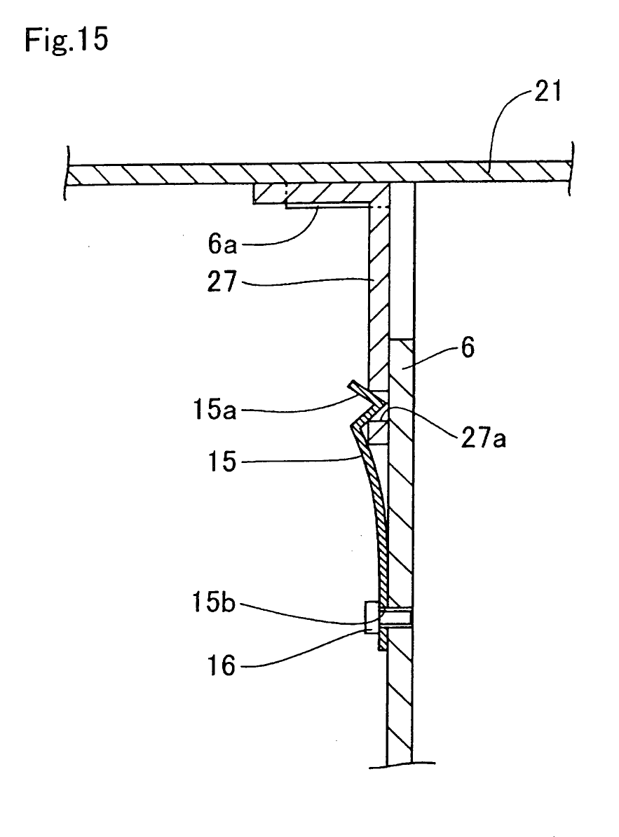

The state of engagement of the flat springs 13 and the flat spring connectors 25 is a state wherein the flat spring connector 25 is interposed between the side surface of the chassis 1 and the contact 13a of the flat spring 13, and a state wherein the convexity of the convexity 13a of the flat spring 13 has two points of contact with the top and bottom of the slot 25a of the flat spring connector 25, as shown in FIGS. 13 and 14. Furthermore, the connectors 26 (refer to FIG. 4) and the flat springs 13 are engaged in a similar manner to the engagement of the flat springs 13 and the flat spring connectors 25 shown in fogs. 13 and 14. Furthermore, as shown in FIG. 15, the flat spring connectors 27 provided on the bottom surface of the top panel of the cover 21, interposed between the side surface of the cover top panel support member 6 and the contact 15a of the flat spring 15 mounted on the cover top panel support member 6 on the chassis 1 side, and the convexity of the contact 15a of the flat spring 15 has two points of contact at the top and bottom of the slot 27a. When the flat spring connectors 27 are engaged with the flat spring 15, downward bending deformation of the center part of the top panel of the relatively weak cover 21 can be prevented since the center part of the top panel of the cover 21 is supported by the top part 6a of the cover top panel support member 6. In this way, a state of electrical continuity exists between the cover 21 and the chassis 1.

In the previously described state wherein positioning is accomplished by the positioning members (positioning pins 11 and guide members 22) and electrical continuity is completed by the conducting members (flat springs 13 and 15, and flat spring connectors 25 through 27), the cover 21 is screw anchored at the female threaded parts 1c of the chassis 1 through the screw holes 21e of the cover 21 by means of screws 28.

In the first conveyance device 102 of the present embodiment, since the positioning members for determining the position of the cover 21 and the chassis 1 are constructed so as to have positioning pins 11 provided on the chassis 1 side and guide members 22 provided with an insertion slot 22a on the cover 21 side, the chassis 1 and the cover 21 can be easily positioned by the engagement of the positioning pins 11 and the insertion holes 22a of the guide members 22 without using the side surface of the chassis 1. In this way, freedom of design is improved compared to a conventional construction in which positioning is accomplished by having cover claws engage the four outer sides of a chassis (electronic device body). Furthermore, since the guide members 22 and the positioning pins 11 which form the positioning members are not exposed outside the device after the cover 21 is mounted, the inconvenience of catching objects on parts of the positioning members exposed outside the device is eliminated.

In the present embodiment, since a power unit 3 is provided on the chassis 1 and static electricity readily accumulates on the cover 21, several (7 sets) of conducting members are provided which include the flat springs 13 and 15 and the flat spring connectors 25 through 27 so as to eliminate the static electricity of the cover 21. For this reason, it becomes difficult to mount the cover 21 on the chassis 1 because the seven sets of flat springs 13 and 15 and seven flat spring connectors 25 through 27 must be respectively engaged when mounting the cover 21 on the chassis 1. In this case, however, the cover 21 can be easily mounted on the chassis 1 using the positioning members formed by the positioning pins 11 and the guide members 22 of the present embodiment, since the flat spring connectors 25 through 27 engage the flat springs 13 and 15 when positioning the cover 21 and the chassis 1. Accordingly, the present embodiment is particularly effective when the power unit 3 is provided on the chassis 1.

Furthermore, in the first conveyance device 102 of the present embodiment, the number of positioning members can be reduced compared to when positioning members are provided at four locations equally spaced on the front and back and in lateral symmetry, by arranging two positioning members formed by the positioning pins 11 and guide members 22 in lateral asymmetry on the diagonal.

In addition, because the positioning pins 11 are formed of metal and the guide members 22 are formed of resin in the first conveyance device 102 of the present embodiment, the breakage of both the positioning pins 11 and the guide members 22 can be prevented because the resin guide members 22 will break before the metal positioning pins 11 will break when the positioning pins 11 engage the insertion holes 22a of the guide members 22. By mounting the metal positioning pins 11 on the chassis 1 which has a relatively high mechanical strength and allows positioning accuracy, and mounting the resin guide members 22 on the cover 21 which has a relatively low mechanical strength and allows poor positioning accuracy, only the guide members 22 which are mounted with poor positioning accuracy are damaged without damaging the positioning pins 11 which are mounted with high positioning accuracy when a strong force is applied when the positioning pins 11 engage the insertion holes 22a of the guide members 22. Since, by mounting the guide members 22 on the cover 21 side which allows easy directional movement compared to the chassis 1, the cover 21 can be easily moved in a direction (position) to allow easy replacement of the guide member 22 when a guide member 22 is damaged, and replacement of the guide members 22 is readily accomplished.

The electrical continuity between the chassis 1 and the cover 21 is reliably ensured because the convexity of the flat springs 13 make contact at two points at the top and bottom of the slots 25a and 26a by providing the flat spring connectors 25 and 26 with the slots 25a and 26a for engaging the convexity of the contact 13a of the flat spring 13. In this way, accumulation of static electricity charge on the cover 21 can be reliably eliminated. Furthermore, since the convexity of the contact 15a of the flat spring 15 makes contact at two points at the top and bottom of the slot 27a by providing the slot 27a on the flat spring connector 27, electrical continuity between the chassis 1 and the cover top panel support member 6 can be reliably ensured.

In the present embodiment described above, the operation of positioning the cover 21 relative to the chassis 1 is readily accomplished because the positioning pins 11 easily engage the insertion holes 22a of the guide members 22 since the tapered part 11a is provided at the tip of the positioning pin 11 and the bevel part 22c is provided at the bottom end of the insertion hole 22a of the guide member 22.

By providing a smooth part 11d on the positioning pin 11, the smooth part 11d can be gripped when the threaded part 11c of the positioning pin 11 is tightened and anchored by a nut 12. In this way, the operation of mounting the positioning pin 11 is readily accomplished since rotation of the positioning pin 11 is prevented when the nut 12 is tightened.

The presently disclosed embodiments are not limited to the points described in the examples. The scope of the present invention is expressed by the scope of the claims and not by the description of the embodiments, and the present invention includes all modifications within scope and equivalent meanings of the scope of the claims.

For example, although the previously described embodiment is an example using positioning pins as a convexity forming a positioning member and insertion holes of a guide member as concavities forming a positioning member, the present invention is not limited to this arrangement and the positioning members may by constructed by convexities other than the positioning pin and concavities other than the insertion hole.

Although the above mentioned embodiment is an example providing positioning pins on the chassis side and guide members having insertion holes on the cover side, the present invention is not limited to this arrangement inasmuch as the positioning pins may be provided on the cover side and the guide members having insertion holes may be provided on the chassis side.

Although the embodiment above is an example in which a positioning member formed by a positioning pin and guide member having an insertion hole is provided in the first conveyance device, the present invention is not limited to this arrangement inasmuch as an identical effectiveness can be obtained by a positioning member formed by a positioning pin and guide member having an insertion hole provided in the second conveyance device.

Although the previously described embodiment is an example in which a positioning member formed by a positioning pin and guide member having an insertion hole is provided in the first conveyance device as an example of an electronic device, the present invention is not limited to this arrangement inasmuch as an identical effectiveness can be obtained even when a positioning member formed by a positioning pin and guide member having an insertion hole is provided in an electronic device other than a conveyance device.

Although the abovementioned embodiment is an example wherein two positioning members formed by a positioning pin and guide member having an insertion hole are provided in laterally asymmetric locations, the present invention is not limited to this arrangement inasmuch as three or more positioning members formed by a positioning pin and guide member having an insertion hole may be provided. Moreover, the positioning members may be laterally symmetrical.

Although the embodiment above is an example using conducting members formed of flat springs and flat spring connectors as conducting members for establishing electrical continuity between the cover and the chassis, the present invention is not limited to this arrangement inasmuch as conducting members other than the flat springs and flat spring connectors may be used. For example, a metal gasket may be used as a conducting member so as to obtain electrical continuity between the cover and the chassis through the gasket.

Although the previously described embodiment is an example in which flat springs are mounted on the conveyance device body and flat spring connectors are mounted on the cover, the present invention is not limited to this arrangement inasmuch as the flat springs may be mounted on the cover and the flat spring connectors may be mounted on the conveyance device body.

Although the abovementioned embodiment is an example in which the present invention is applied to an analysis system including a urine analyzer and conveyance devices, the present invention is not limited to this arrangement inasmuch as the present invention may also be applied to analysis systems including conveyance devices and other analyzers such as, for example, blood analyzers.

Although the embodiment above is an example in which the present invention is applied to an analysis system including a urine analyzer and conveyance devices, the present invention is not limited to this arrangement inasmuch as the present invention also is applicable to systems which require blocking of a static charge on the cover in electronic devices other than analysis system.

1. An electronic device comprising:
an electronic device body;
a cover mounted on the electronic device body;
a conducting member providing electrical continuity between the electronic device body and the cover; and
a positioning member for determining the relative positions of the electronic device body and the cover, including a convexity provided on either the electronic device body or the cover, and a concavity provided on the other among the electronic device body or the cover, the convexity and the concavity being engageable one another.

2. The electronic device of claim 1, wherein at least two positioning members are provided at laterally asymmetrical positions on the electronic device body.

3. The electronic device of claim 1, wherein the convexity of the positioning member is provided on the electronic device body, and the concavity of the positioning member is provided on the cover.

4. The electronic device of claim 1, wherein the concavity of the positioning member includes a guide member having an insertion hole into which the convexity being inserted.

5. The electronic device of claim 1, wherein the convexity includes a tapered part on its tip.

6. The electronic device of claim 1, wherein the convexity includes a threaded part on the base end and a smooth part provided above the threaded part.

7. The electronic device of claim 1, wherein the convexity is formed of metal, and the concavity is formed of resin.

8. The electronic device of claim 1, wherein the convexity comprises a positioning pin and the concavity comprises a insertion hole into which the positioning pin is inserted,
the positioning pin is provided such that the axial direction of the positioning pin is substantially parallel to the mounting direction of the cover; and
the concavity is arranged such that the direction of extension of the insertion hole is substantially parallel to the axial direction of the positioning pin.

9. The electronic device of claim 1, wherein the conducting member includes a flat spring provided on either the electronic device body or the cover, and a flat spring connector for engaging the flat spring provided on the other of either the electronic device body or cover, and the flat spring connector is interposed between the flat spring and the inner wall of either the electronic device body or the cover.

10. The electronic device of claim 9, wherein the flat spring has a spring convexity; and
the flat spring connector has a slot for engaging the spring convexity.

11. The electronic device of claim 9, wherein the convexity and concavity of the positioning members are arranged such that they engage one another before the flat spring and the flat spring connector engages when mounting the cover on the electronic device body.

12. The electronic device of claim 1, further comprising a power source which is provided on the electronic device body.

13. The electronic device of claim 1, wherein the electronic device is a conveyance device for transporting a specimen container which contains a specimen.

14. An analysis system comprising:
the conveyance device of claim 13; and
an analysis device for analyzing a specimen accommodated in a specimen container transported by the conveyance device.

15. An electronic device comprising:
an electronic device body;
a cover mounted on the electronic device body;
a conducting member providing electrical continuity between the electronic device body and the cover;
positioning members for determining the relative positions of the electronic device body and the cover;
wherein the positioning member is provided in an inner part of a space formed by mounting a cover on the electronic device body.

16. The electronic device of claim 15, wherein the conducting member is provided in an inner part of the space formed by mounting a cover on the electronic device body.

17. An analysis system comprising:
the electronic device of claim 15; and
an analysis device for analyzing a specimen;
wherein the electronic device is a conveyance device for transporting a specimen container accommodating a specimen so as to supply the specimen to the analysis device.

18. A conveyance device for transporting a specimen container accommodating a specimen comprising:
a device body including a container transfer for transporting a specimen container;
a cover mounted on the device body;
a conducting member for providing electrical continuity between the cover and the device body; and
positioning members for determining the relative positions of the device body and the cover.

19. The conveyance device of claim 18, wherein the device body includes the container transfer, and a chassis accommodating the container transfer, and the positioning member determines the relative positions of the cover and the chassis.

20. The conveyance device of claim 18, wherein the device body includes the container transfer, and a chassis accommodating the container transfer, and the conducting member provides electrical continuity between the cover and the chassis.

21. An analysis system comprising:
the conveyance device of claim 18; and
an analysis device for analyzing a specimen accommodated in a specimen container transported by the conveyance device.
